(19) United States
(12) Patent Application Publication
(10) Pub. No.: US 2016/0368801 A1
(43) Pub. Date: Dec. 22, 2016

(54) METHOD AND APPARATUS FOR TREATING WASTEWATER CONTAINING CATIONIC SURFACTANT

(71) Applicant: KURITA WATER INDUSTRIES LTD., Tokyo (JP)

(72) Inventors: Nozomu IKUNO, Tokyo (JP); Yuushi MAEDA, Tokyo (JP)

(21) Appl. No.: 14/901,847

(22) PCT Filed: Jun. 24, 2014
(86) PCT No.: PCT/JP2014/066629

§ 371 Date: Dec. 29, 2015

(30) Foreign Application Priority Data
Jul. 2, 2013 (JP) 2013-138915

(51) Int. Cl. C02F 9/00; B01D 61/04; B01D 61/02; C02F 1/28; C02F 1/66

(52) U.S. Cl. CPC C02F 9/00; C02F 1/283; C02F 1/66; B01D 61/022; B01D 61/025; B01D 61/04; C02F 2101/301

(57) ABSTRACT

When recovering water by performing a reverse-osmosis-membrane separation treatment on wastewater containing a cationic surfactant such as process wastewater from the electronics industry, high-quality treated water is obtained consistently over the long term while preventing blockage of the reverse-osmosis membrane caused by the cationic surfactant. A reverse-osmosis-membrane separation treatment is performed using a first reverse-osmosis-membrane separation device (3) on wastewater containing a cationic surfactant such as process wastewater from the electronics industry after first adjusting the same to a pH of 3-5, a reverse-osmosis-membrane separation treatment is performed using a second reverse-osmosis-membrane separation device (4) on permeated water from the first reverse-osmosis-membrane separation device (3) after first adjusting the same to a pH of 6.5-10.5, and the permeated water from the second reverse-osmosis-membrane separation device (4) is recovered as treated water.

### FIELD OF THE INVENTION

The present invention relates to a method and an apparatus for treating wastewater containing a cationic surfactant, which is discharged from an electronic industry process and the like, with efficiency.

### BACKGROUND OF THE INVENTION

In electronic industry processes such as a semiconductor process and an LCD process, wastewater from an electronic industry process has been recovered and reused in order to reduce the environmental load and the wastewater treatment cost. In order to recover and reuse wastewater discharged from an electronic industry process, the following treatment method (1) or (2) is commonly employed.

(1) Wastewater is subjected to a biological treatment in which an activated sludge method or a carrier is used; coagulation-flotation-filtration, coagulation-sedimentation-filtration, or a membrane separation treatment using an ultrafiltration (UF) membrane or a microfiltration (MF) membrane is subsequently performed in order to separate and remove bacteria and SS from water treated by the biological treatment; a desalination treatment is then performed using reverse osmosis (RO) membrane separation; and water that permeated through the RO membrane is recovered.

(2) The biological treatment performed in the method (1) is omitted; coagulation-flotation-filtration, coagulation-sedimentation-filtration, or a membrane separation treatment using a UF membrane or an MF membrane is performed in order to separate and remove SS from wastewater; a desalination treatment is subsequently performed using RO membrane separation; and water that permeated through the RO membrane is recovered.

In the methods (1) and (2) above, an activated-carbon treatment is performed prior to the RO-membrane-separation treatment in order to remove oxidizing substances such as residual chlorine and hydrogen peroxide contained in RO-membrane feedwater.

In an electronic industry process, a cationic surfactant may be used as a detergent for cleaning wafers, glass substrates, and the like. The cationic surfactant contained in wastewater from an electronic industry process is difficult to be removed by the biological treatment, the SS separation treatment, and the activated-carbon treatment used in the treatment method (1) or (2) above, but can be removed using the RO-membrane separation. Since a cationic surfactant is a substance that may cause an RO membrane to be clogged, an inflow of a cationic surfactant into the RO-membrane-separation device may cause the RO membrane to be clogged, which reduces the flow rate of permeate water with time. A cationic surfactant causes an RO membrane to be clogged because the cationic surfactant adheres onto the surface of the RO membrane due to an electrostatic attractive force since the cationic surfactant is positively charged while the RO membrane is negatively charged under a neutral pH condition.

Under an acidic pH condition, an RO membrane has a positive zeta potential, and the resulting repulsive force prevents the cationic surfactant from adhering onto the surface of the membrane. Thus, reducing the pH of RO feedwater reduces the likelihood of the membrane being clogged with the cationic surfactant.

There has been proposed a method using this principle in which the pH of wastewater containing a cationic surfactant, such as wastewater from washing of food containers, is controlled to be 6 or less and the wastewater is subsequently subjected to an RO-membrane treatment (Patent Literature 1).

In the method described in Patent Literature 1, wastewater from sterilization washing of PET bottles which contains a cationic surfactant used as a conveyor lubricant is treated using a sanitizer-decomposing device, the pH of the wastewater is subsequently controlled to be 6 or less and is preferably controlled to be 5 to 6, and the wastewater is then treated using an RO-membrane-treatment device. The treated water is reused as wash water.

### CITATION LIST

### Patent Literature

Patent Literature 1: Japanese Patent Publication 2006-247576 A

### SUMMARY OF THE INVENTION

### Object of the Invention

Since reducing the pH of RO feedwater in the RO-membrane-separation treatment reduces a salt rejection, which reduces the degree of purity of the resulting water, it is not suitable to reduce the pH of RO feedwater in water recovery for an electronic industry process.

Accordingly, an object of the present invention is to provide a method and an apparatus that may reduce, when wastewater containing a cationic surfactant, such as wastewater from an electronic industry process, is subjected to an RO-membrane-separation treatment and the resulting treated water is recovered, the likelihood of the RO membrane being clogged with the cationic surfactant and thereby enable high-quality treated water to be produced for a long period of time with consistency.

### Solution to Problem

The inventors conducted investigation for solving the above problems, and obtained findings that treated water having a high quality was obtained by treating wastewater containing a cationic surfactant at a low pH condition by an RO membrane (reverse-osmosis-membrane) separation, and subsequently treating permeate water by RO membrane separation at a raised pH, while preventing clogging of the RO membrane.

The present invention was accomplished based on the findings, and the gist thereof is as follows:

[1] A method for treating wastewater containing a cationic surfactant, the method comprising a first reverse-osmosis-membrane-separation step in which a pH of wastewater containing a cationic surfactant is controlled to be 3 to 5 and the wastewater containing a cationic surfactant is subsequently subjected to a reverse-osmosis-membrane-separation treatment; and a second reverse-osmosis-membrane-separation step in which a pH of reverse-osmosis-membrane permeate water produced in the first reverse-osmosis-membrane-separation step is controlled to be 6.5 to 10.5 and the reverse-osmosis-membrane permeate water is subsequently subjected to a reverse-osmosis-membrane-separation treatment.

[2] The method for treating wastewater containing a cationic surfactant according to [1], wherein the wastewater containing a cationic surfactant is subjected to an activated-carbon treatment prior to being treated in the first reverse-osmosis-membrane-separation step.

[3] The method for treating wastewater containing a cationic surfactant according to [1] or [2], wherein the wastewater containing a cationic surfactant is wastewater from an electronic industry process, and wherein reverse-osmosis-membrane permeate water produced in the second reverse-osmosis-membrane-separation step is recovered.

[4] An apparatus for treating wastewater containing a cationic surfactant, the apparatus comprising: a first reverse-osmosis-membrane-separation device for controlling a pH of wastewater containing a cationic surfactant to be 3 to 5 and subsequently subjecting the wastewater containing a cationic surfactant to a reverse-osmosis-membrane-separation treatment; and a second reverse-osmosis-membrane-separation device for controlling a pH of reverse-osmosis-membrane permeate water produced by the first reverse-osmosis-membrane-separation means to be 6.5 to 10.5 and subsequently subjecting the reverse-osmosis-membrane permeate water to a reverse-osmosis-membrane-separation treatment.

[5] The apparatus for treating wastewater containing a cationic surfactant according to [4], the apparatus comprising an activated carbon column in which the wastewater containing a cationic surfactant is treated, the activated carbon column being disposed upstream of the first reverse-osmosis-membrane-separation device.

[6] The apparatus for treating wastewater containing a cationic surfactant according to [4] or [5], wherein the wastewater containing a cationic surfactant is wastewater from an electronic industry process, and wherein reverse-osmosis-membrane permeate water produced by the second reverse-osmosis-membrane-separation device is recovered. Advantageous Effects of the Invention

According to the present invention, a first RO-membrane-separation treatment performed at a pH of 3 to 5, that is, under an acidic condition, enables a cationic surfactant to be separated and removed from wastewater containing a cationic surfactant while reducing the likelihood of the membrane being clogged with the cationic surfactant, and a second RO-membrane-separation treatment performed at a pH of 6.5 to 10.5, that is, under a neutral to alkali condition, enables salts contained in the wastewater to be removed at a high level. Since a cationic surfactant contained in wastewater has been removed by the first RO-membrane-separation treatment, the likelihood of the membrane being clogged with the cationic surfactant is reduced in the second RO-membrane-separation treatment. A consistent and efficient treatment can be performed while maintaining the flow rate of water that permeates through the first and second RO membranes at a high level for a long period of time.

### BRIEF DESCRIPTION OF THE DRAWINGS

FIG. 1 is a block diagram illustrating a method and apparatus for treating wastewater containing a cationic surfactant according to an embodiment of the present invention.

FIG. 2 is a graph illustrating the results of Test Example 1.

### DESCRIPTION OF EMBODIMENTS

A method and an apparatus for treating wastewater containing a cationic surfactant according to an embodiment of the present invention is described in detail below with reference to the attached drawings.

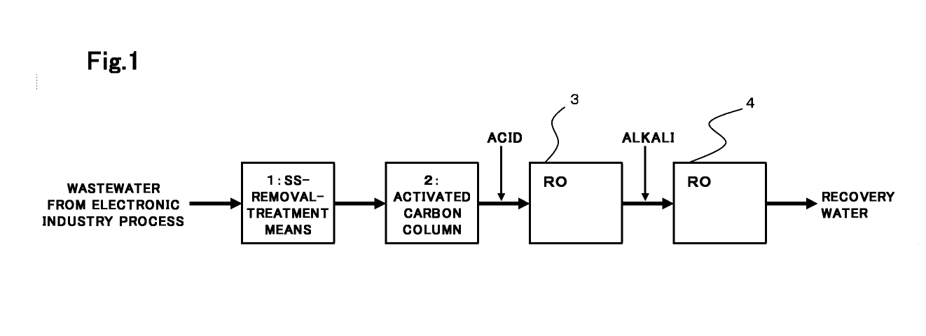

FIG. 1 is a block diagram illustrating a method and an apparatus for treating wastewater containing a cationic surfactant according to an embodiment of the present invention.

In FIG. 1, wastewater containing a cationic surfactant which is discharged from an electronic industry process such as a semiconductor process or an LCD process is treated by SS-removal-treatment means 1 where the treatment may be coagulation-flotation-filtration, coagulation-sedimentation-filtration, or a membrane separation treatment using a UF membrane or an MF membrane, whereby SS contained in the wastewater is removed. Water treated by the SS-removal treatment is subjected to an activated-carbon treatment by being passed through an activated carbon column 2. An acid such as hydrochloric acid or sulfuric acid is added to water treated in the activated carbon column 2 in order to control the pH of the treated water to 3 to 5. The water treated using activated carbon is subjected to an RO-membrane-separation treatment using a first RO-membrane-separation device 3. An alkali such as sodium hydroxide or potassium hydroxide is added to water that permeated through the first RO-membrane-separation device 3 in order to control the pH of the permeate water to 6.5 to 10.5, and the permeate water is subsequently subjected to an RO-membrane-separation treatment using a second RO-membrane-separation device 4. Water that permeated through the second RO-membrane-separation device 4 is recovered as recovery water and reused.

In general, wastewater from an electronic industry process contains, in addition to a cationic surfactant, low-molecular-weight organic substances such as IPA (isopropyl alcohol), ethanol, methanol, acetic acid and acetates, acetone, TMAH (trimethylammonium hydroxide), MEA (monoethanolamine), and DMSO (dimethyl sulfoxide) and, typically, about 5 to 100 mg/L of SS (suspended solids) such as colloidal silica. Thus, SS are removed from the wastewater using the SS-removal-treatment means 1.

In a coagulation treatment performed by the SS-removal-treatment means 1, one or more inorganic flocculants such as an aluminium-based flocculant (e.g., polyaluminium chloride or aluminium sulfate) and an iron-based flocculant (e.g., ferric chloride or polyiron sulfate) are used as a flocculant. The amount of these inorganic flocculants added to wastewater from an electronic industry process is generally about 50 to 500 mg/L.

Water treated by the SS-removal treatment in the SS-removal-treatment means 1 is passed into the activated carbon column 2, in which oxidizing substances such as residual chlorine and hydrogen peroxide are removed. Conditions under which the treatment is performed in the activated carbon column 2 are not particularly limited.

Water treated in the activated carbon column 2 is normally neutral water having a pH of 5 to 8. An acid is added to the water treated using activated carbon, and the water treated using activated carbon is subsequently subjected to an RO-membrane-separation treatment in the first RO-membrane-separation device 3 at a pH of 3 to 5 in order to remove a cationic surfactant contained in the water treated using activated carbon. If the pH in the first RO-membrane-separation device 3 exceeds 5, the RO membrane becomes negatively charged and the cationic surfactant becomes adsorbed on the RO membrane, which may cause the membrane to be clogged. Controlling the pH to be 3 to 5 is enough to positively charge the RO membrane. Reducing the pH excessively increases the amount of acid used and the amount of alkali used for controlling pH in the subsequent alkali-addition step, which results in a high chemical cost. With the acid resistance of the RO membrane also taken into consideration, the pH is preferably set to 3 to 5 and is particularly preferably set to 3.5 to 4.5.

The RO membrane included in the first RO-membrane-separation device 3 is preferably a polyamide membrane, a polyvinyl alcohol membrane, or the like. The water recovery percentage of the first RO-membrane-separation device 3 is preferably set to about 60% to 90%.

An alkali is added to water that permeated through the first RO-membrane-separation device 3 in order to control the pH of the permeate water to 6.5 to 10.5. The permeate water is subsequently subjected to a desalination treatment in the second RO-membrane-separation device 4. If the pH in the second RO-membrane-separation device 4 is excessively low, a sufficiently high salt rejection may fail to be achieved. An excessively high pH in the second RO-membrane-separation device 4 is not suitable for recovery and reuse of the permeate water. With the prevention of degradation of the membrane also taken into consideration, the pH in the second RO-membrane-separation device 4 is particularly preferably set to 7 to 9.

The RO membrane included in the second RO-membrane-separation device 4 is preferably a polyamide membrane. The water recovery percentage of the second RO-membrane-separation device 4 is preferably set to about 80% to 90%.

The above-described two-stage RO-membrane-separation treatment enables treated water having a TOC concentration of 50 μg/L or less, that is, for example, 20 to 30 μg/L, and an electric conductivity of 10 mS/m or less, that is, for example, about 2 mS/m, to be produced. This treated water can be fed to and reused at each point of use as recovery water.

FIG. 1 illustrates an exemplary embodiment of the present invention, and the present invention is not limited to the one illustrated in FIG. 1 without departing from the scope thereof. For example, biological treatment means may be disposed upstream of the SS-removal-treatment means 1. The activated carbon column 2 may be omitted. While FIG. 1 illustrates an example case where the wastewater containing a cationic surfactant to be treated is wastewater from an electronic industry process, the wastewater containing a cationic surfactant to be treated in the present invention is not limited to wastewater from an electronic industry process and may be wastewater containing a cationic surfactant other than wastewater from an electronic industry process. Since the two-stage RO-membrane-separation treatment is capable of increasing a salt rejection, the present invention may be particularly advantageously used for recovery and reuse of wastewater from an electronic industry process.

### EXAMPLES

The present invention is described further in detail with Test Example, Example, and Comparative Example below.

### Test Example 1

Raw water, which was wastewater containing 2 mg/L of a monoalkyl ammonium chloride-based cationic surfactant (“Arquad T” produced by Lion Corporation), was treated using the apparatus illustrated in FIG. 1. While the pH of RO feedwater passed into a first RO-membrane-separation device 3 was changed, the relationship between the RO feedwater and the change in the permeate flux of an RO membrane included in the first RO-membrane-separation device 3 with time was determined.

In SS-removal-treatment means 1, 200 mg/L of ferric chloride was added to the raw water and coagulation, flotation, and filtration were subsequently performed. The filtered water was treated in an activated carbon column 2, and an acid (hydrochloric acid) or an alkali (sodium hydroxide) was subsequently added to the treated water as needed in order to control the pH of the treated water to be 4, 5, 7, or 9. Then, an RO-membrane-separation treatment was performed in an RO-membrane-separation device 3. The RO-membrane-separation device 3 used included an aromatic polyamide RO membrane “ES-20” (NaCl rejection: 99.5%) produced by Nitto Denko Corporation and was operated at a water recovery percentage of 75%.

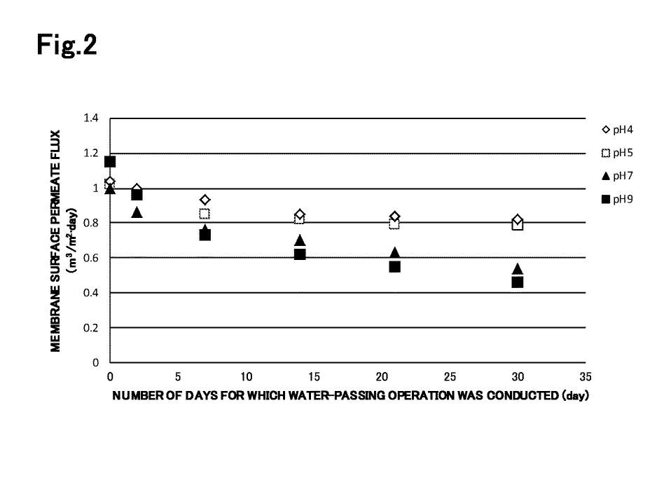

FIG. 2 illustrates the changes in the permeate flux of the RO membrane with time which each correspond to a specific one of the pHs of the RO feedwater.

The results illustrated in FIG. 2 confirm that permeate flux significantly decreased with time in the case where the pH of the RO feedwater was 7 or 9 and, in the case where the pH of the RO feedwater was 4 or 5, the degree of a reduction in permeate flux was small even after 30 days, which proves that the likelihood of the membrane being clogged with a cationic surfactant was reduced.

### Example 1

Raw water, which was wastewater containing 2 mg/L of a monoalkyl ammonium chloride-based cationic surfactant (“Arquad T” produced by Lion Corporation), was treated using the apparatus illustrated in FIG. 1.

In SS-removal-treatment means 1, 200 mg/L of ferric chloride was added to the raw water and coagulation, flotation, and filtration were subsequently performed. The filtered water was treated in an activated carbon column 2, and an acid (hydrochloric acid) was subsequently added to the treated water in order to control the pH of the treated water to be 4. Then, an RO-membrane-separation treatment was performed in an RO-membrane-separation device 3. The first RO-membrane-separation device 3 used included an aromatic polyamide RO membrane “ES-20” (NaCl rejection: 99.5%) produced by Nitto Denko Corporation and was operated at a water recovery percentage of 75%.

An alkali (sodium hydroxide) was added to water that permeated through the first RO-membrane-separation device 3 in order to control the pH of the permeate water to be 7. the permeate water was subjected to an RO-membrane-separation treatment in a second RO-membrane-separation device 4. The second RO-membrane-separation device 4 used included an aromatic polyamide RO membrane “ES-20” (NaCl rejection: 99.5%) produced by Nitto Denko Corporation and was operated at a water recovery percentage of 90%.

The qualities of water that permeated through the first RO-membrane-separation device 3 and water that permeated through the second RO-membrane-separation device 4 were measured. Table 1 summarizes the results. A reduction in the permeate flux of the second RO-membrane-separation device 4 which occurred from the time that the treatment was started until a 30-day water-passing operation was terminated was measured. Table 1 summarizes the results.

### Comparative Example 1

A treatment was performed as in Example 1, except that the pH of the water (pH: 4.2) that permeated through the first RO-membrane-separation device 3 was not controlled and the permeate water was directly subjected to an RO-membrane-separation treatment in the second RO-membrane-separation device 4. The qualities of water that permeated through the first RO-membrane-separation device 3 and water that permeated through the second RO-membrane-separation device 4 were measured. Table 1 summarizes the results. A reduction in the permeate flux of the second RO-membrane-separation device 4 which occurred from the time that the treatment was started until a 30-day water-passing operation was terminated was measured. Table 1 summarizes the results.

TABLE 1

| | | | | | Percentage |
|---|---|---|---|---|---|
| | | | | | reduction in |
| | Water that permeated through | | Water that permeated through | | permeate flux |
| | first RO-membrane-separation | | second RO-membrane- | | of second RO- |
| | device | | separation device | | membrane- |
| | | Electric | | Electric | separation |
| | TOC | conductivity | TOC | conductivity | device |
| | (mg/L) | (mS/m) | (mg/L) | (mS/m) | (%) |
| Example 1 | 0.15 | 25 | 0.04 | 1.4 | 0 |
| Comparative example 1 | | | 0.1 | 7 | 0 |

 Percentage reduction =
$\frac{Initial permeate flux - Permeate flux after 30 days}{Initial permeate flux} \times 100$

The quality of water that permeated through the first RO-membrane-separation device in Example 1 confirmed that it is not possible to produce quality treated water that can be suitably used as recovery water by performing a single-stage RO-membrane-separation treatment.

The quality of water that permeated through the second RO-membrane-separation device in Comparative example 1 confirmed that, even in the case where a two-stage RO-membrane-separation treatment was performed, it is not possible to produce quality treated water unless the pH of water that permeated through the first RO-membrane-separation device is controlled.

In contrast, it was confirmed that, according to the present invention in which the first RO-membrane-separation treatment is performed at a pH of 3 to 5 and the second RO-membrane-separation treatment is performed at a pH of 6.5 to 10.5, quality treated water may be produced for a long period of time with consistency without occurrence of clogging of the membrane.

Although the present invention has been described in detail with reference to a particular embodiment, it is apparent to a person skilled in the art that various modifications can be made therein without departing from the spirit and scope of the present invention.

The present application is based on Japanese Patent Application No. 2013-138915 filed on Jul. 2, 2013, which is incorporated herein by reference in its entirety.

1. A method for treating wastewater containing a cationic surfactant, the method comprising:
a first reverse-osmosis-membrane-separation step in which a pH of wastewater containing a cationic surfactant is controlled to be 3 to 5 and the wastewater containing a cationic surfactant is subsequently subjected to a reverse-osmosis-membrane-separation treatment; and
a second reverse-osmosis-membrane-separation step in which a pH of reverse-osmosis-membrane permeate water produced in the first reverse-osmosis-membrane-separation step is controlled to be 6.5 to 10.5 and the reverse-osmosis-membrane permeate water is subsequently subjected to a reverse-osmosis-membrane-separation treatment.

2. The method for treating wastewater containing a cationic surfactant according to claim 1, wherein the wastewater containing a cationic surfactant is subjected to an activated-carbon treatment prior to being treated in the first reverse-osmosis-membrane-separation step.

3. The method for treating wastewater containing a cationic surfactant according to claim 2, wherein the wastewater containing a cationic surfactant is subjected to an SS-removal treatment prior to being subjected to the activated-carbon treatment.

4. The method for treating wastewater containing a cationic surfactant according to claim 1, wherein the wastewater containing a cationic surfactant is wastewater from an electronic industry process, and wherein reverse-osmosis-membrane permeate water produced in the second reverse-osmosis-membrane-separation step is recovered.

5. An apparatus for treating wastewater containing a cationic surfactant, the apparatus comprising:
a first reverse-osmosis-membrane-separation device for controlling a pH of wastewater containing a cationic surfactant to be 3 to 5 and subsequently subjecting the wastewater containing a cationic surfactant to a reverse-osmosis-membrane-separation treatment; and
a second reverse-osmosis-membrane-separation device for controlling a pH of reverse-osmosis-membrane permeate water produced by the first reverse-osmosis-membrane-separation means to be 6.5 to 10.5 and subsequently subjecting the reverse-osmosis-membrane permeate water to a reverse-osmosis-membrane-separation treatment.

6. The apparatus for treating wastewater containing a cationic surfactant according to claim 5, the apparatus comprising an activated carbon column in which the wastewater containing a cationic surfactant is treated, the activated carbon column being disposed upstream of the first reverse-osmosis-membrane-separation device.

7. The apparatus for treating wastewater containing a cationic surfactant according to claim 6, the apparatus comprising an SS-remover for removing SS in the wastewater containing a cationic surfactant to an SS-removal treatment, the SS-remover being disposed upstream of the activated carbon column.

8. The apparatus for treating wastewater containing a cationic surfactant according to claim 5, wherein the wastewater containing a cationic surfactant is wastewater from an electronic industry process, and wherein reverse-osmosis-membrane permeate water produced by the second reverse-osmosis-membrane-separation device is recovered.
